(19) United States
(12) Patent Application Publication
(10) Pub. No.: US 2008/0139726 A1
(43) Pub. Date: Jun. 12, 2008

(54) REDUCED-FORMALDEHYDE DISPERSIONS OF MICROCAPSULES OF MELAMINE-FORMALDEHYDE RESINS

(75) Inventors: Herbert EISERMANN, Mannheim (DE); Jacques Nervo, Ludwigshafen (DE); Ralf Biastoch, Speyer (DE); Gabriele Frank, Ludwigshafen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/950,511

(22) Filed: Dec. 5, 2007

(30) Foreign Application Priority Data
Dec. 6, 2006 (EP) 06125508.9
Dec. 15, 2006 (EP) 06126221.8

(51) Int. Cl. C08L 39/04; C08K 3/10

(52) U.S. Cl. 524/436

(57) ABSTRACT

The present invention relates to the use of calcium salts for reducing the formaldehyde emission of microcapsule dispersions based on melamine-formaldehyde resins. The invention also relates to a process for the preparation of a dispersion of microcapsules by condensation of partly methylated melamine-formaldehyde resin in water, in which the substantially water-insoluble material forming the capsule core is dispersed, in the presence of an anionic protective colloid, and to the dispersions of microcapsules which are obtained by this process and to the use thereof for the preparation of printing inks and paper coating materials.

The invention relates to the use of calcium salts for reducing the formaldehyde emission of microcapsule dispersions based on melamine-formaldehyde resins. The invention also relates to a process for the preparation of a dispersion of microcapsules by condensation of partly methylated melamine-formaldehyde resin in water in which the substantially water-insoluble material forming the capsule core is dispersed, in the presence of an anion protective colloid, and to the dispersions of microcapsules which are obtained by this process and to the use thereof for the preparation of printing inks and paper coating materials.

Microdisperse particles which may have diameters in the range from about 0.1 to 100 μm have a broad application in various areas. For example, they are used as solid spheres in polishes and/or cleaning agents, as spacers in printing inks, as a measurement quantity for medical investigations under the microscope, etc. In addition to the solid spheres, microcapsules which may comprise liquid, solid or gaseous, water-insoluble or substantially insoluble substances as core material are known. For example, melamine-formaldehyde polymers, polyurethane, gelatin, polyamides or polyureas are customary as material for the capsule walls. The use of oil-filled microcapsules for the production of carbonless copy papers is widespread.

For this purpose, the oil-filled microcapsules are incorporated into paper coating materials with which paper substrates are coated. The high coating speeds usual at present require a low viscosity of the paper coating materials, which in turn requires a low viscosity of the microcapsule dispersions. Nevertheless, the capsule concentration of the dispersions should be as high as possible in order to avoid unnecessarily wet work. For achieving a good color strength yield, as narrow a capsule size distribution as possible is furthermore desired.

Dispersions of microcapsules comprising aminoplast resins, such as melamine-formaldehyde resins, comprise more or less free formaldehyde as a result of the preparation. For reasons relating to environmental and occupational hygiene, it is desirable to keep the formaldehyde content as low as possible, but without adversely influencing other properties of the microcapsule dispersions. A distinction should be made between the formaldehyde content of the dispersion itself and the formaldehyde content of the material coated with the dispersion. A low concentration of free formaldehyde in the aqueous capsule dispersion does not necessarily mean that a determination of the formaldehyde content in the coated material, for example by means of the so-called cold water extract according to DIN EN 645 and DIN EN 1541, will give low formaldehyde values.

For reducing the formaldehyde content, it is usual to add formaldehyde scavengers to microcapsule dispersions based on melamine-formaldehyde resins. The most frequently used formaldehyde scavengers include ammonia, urea, ethyleneurea and melamine, which more or less effectively reduce the residual content of formaldehyde in the capsule dispersion.

EP-A-0 383 358 and DE-A-38 14 250 disclose light-sensitive materials which consist of microcapsules whose walls are formed from melamine-formaldehyde resins. For removing excess formaldehyde, urea is added during the curing.

In the processes described in EP-A-319 337 and U.S. Pat. No. 4,918,317, urea is added toward the end of the curing.

EP-A-0 415 273 describes the production and use of mono- and polydisperse solid spherical particles of melamine-formaldehyde condensate. For binding the formaldehyde liberated during the condensation, the use of ammonia, urea or ethyleneurea is proposed.

Microcapsules of melamine-formaldehyde resins, which are distinguished by their uniform capsule size and tightness, are disclosed in EP-A-0 218 887 and EP-A-0 026 914. However, these capsule dispersions still contain residual free formaldehyde, the presence of which is undesired during the further processing.

EP-A-0 026 914 therefore recommends binding the formaldehyde after the curing with ethyleneurea and/or melamine as formaldehyde scavengers.

DE 198 35 114 discloses dispersions of microcapsules based on melamine-formaldehyde resin, the melamine-formaldehyde resin being partly etherified and comprising a water-soluble primary, secondary or tertiary amine or ammonia. Urea is added as a formaldehyde scavenger before the curing.

DE 198 33 347 describes a process for the preparation of microcapsules by condensation of melamine-formaldehyde resins and/or the methyl ethers thereof, urea or urea whose amino groups are linked with an ethylene or propylene bridge being added as formaldehyde scavengers before the curing. Although the dispersions obtained have a low formaldehyde content, the stability of the microcapsules and the viscosity of the microcapsule dispersion are adversely influenced by the addition of urea before the curing.

WO 01/51197 teaches a process for the preparation of microcapsules with condensation of melamine-formaldehyde resins, in which a mixture of melamine and urea is added during the curing.

It is true that the formaldehyde content of the dispersion is regularly reduced by the addition of said formaldehyde scavengers to the prepared microcapsule dispersion or during the preparation of the microcapsule dispersion. However, the formaldehyde content of papers which are coated with coating materials comprising the micrcocapsule dispersions, which can be determined by the cold water extract, cannot be reduced below a certain limit even on addition of large amounts of formaldehyde scavengers.

It is an object of the present invention to provide a process for the preparation of a reduced-formaldehyde dispersion of microcapsules, the formaldehyde content of papers coated with the dispersion, which can be determined by means of the cold water extract, being as low as possible. A further object is to provide low-viscosity microcapsule dispersions, in particular low-viscosity microcapsule dispersions having a high solids content.

These objects are achieved by the use according to the invention of at least one calcium salt for reducing the formaldehyde emission of microcapsule dispersions based on melamine-formaldehyde resins. The invention also relates to a process for the preparation of a dispersion of microcapsules by condensation of partly methylated melamine-formaldehyde resin in water, in which the substantially water-insoluble material forming the capsule core is dispersed, in the presence of an anionic protective colloid, and to the dispersions of microcapsules which are obtained by this process and to the use thereof for the preparation of printing inks and paper coating materials.

In the context of the present invention, calcium salt is to be understood as meaning both organic calcium salts, e.g. calcium acetate, and preferably inorganic calcium salts, such as calcium carbonate, calcium chloride, calcium nitrate and in particular calcium hydroxide.

Preferably from 0.5 to 15% by weight, particularly preferably from 1 to 10% by weight and in particular from 2 to 8% by weight, based on the melamine-formaldehyde resin, of calcium salt are used. Larger amounts of calcium salts are possible but in some cases lead to slight discolorations of the microcapsule dispersions, which may be undesirable depending on the application.

Microcapsule dispersions can in principle be prepared by condensation of a melamine-formaldehyde resin, if appropriate partly methylated, in water, in which the substantially water-insoluble material forming the capsule core is dispersed, in the presence of a protective colloid. Pre-formation of the microcapsules takes place, followed by curing of the capsule wall. The pre-forming preferably takes place at a lower pH, such as a pH from 3 to 6.5, and the curing is then initiated by increasing the temperature. According to the invention, at least one calcium salt is added during and/or after the curing.

The preparation is explained by way of example with reference to a particularly preferred process: according to this process, a dispersion of microcapsules is obtained by condensation of a partly methylated melamine-formaldehyde resin having a molar ratio of melamine:formaldehyde:methanol of 1:3.0:2.0 to 1:6.0:4.0 in water, in which the substantially water-insoluble material forming the capsule core is dispersed, in the presence of a protective colloid, preferably an alkali metal salt of a homo- or copolymer of 2-acrylamido-2-methylpropanesulfonic acid as a protective colloid, at a pH of from 3 to 6.5, by pre-forming the microcapsules at a temperature of from 20 to 50° C. and then curing the capsule wall at from >50 to 100° C., by adding at least one calcium salt during and/or after the curing.

The process according to the invention is generally carried out so that the core material to be encapsulated, the partly methylated melamine-formaldehyde resin having a defined molar ratio of melamine:formaldehyde:methanol of 1:3.0:2.0 to 1:6.0:4.0, preferably 1:3.5:2.2 to 1:4.5:2.8 and in particular about 1:3.9:2.4, the protective colloid and water are combined to give a premix, the premix is adjusted to a pH of from 3 to 6.5 with an acid, preferably formic acid, and the premix is exposed to shearing conditions for dispersing the core material. At a temperature in the range of from 20 to 50° C., preferably about 35° C., the microcapsules pre-form, i.e. a wall of substantially uncrosslinked melamine-formaldehyde resin forms around the dispersed droplets of the core material. The temperature is then increased in order to cure the capsule wall of the microcapsule by formation of crosslinkages. The curing of the capsule wall is already observable above 50° C.; however, 65° C. and particularly preferably 75° C. are chosen as a lower limit of the temperature range for curing. Since the dispersion is an aqueous dispersion, the curing should be carried out at temperatures below 100° C., preferably below 95° C. and particularly preferably below 90° C., as the upper temperature limit. Depending on the pH of the dispersion, the curing is effected at different rates, dispersions curing particularly well at a low pH of from 3 to 5. Above 50° C., however, substantial curing is also observable in the slightly acidic to neutral pH range.

The optimum temperatures for the two steps of capsule pre-forming and curing can be easily determined by simple series experiments, depending on the respective pH.

The heating of the capsule dispersion to the curing temperature can be effected in various ways. In a preferred embodiment, superheated steam is injected into the capsule dispersion. The temperature of the steam is, for example, from 105 to 120° C. and the pressure is from 1.5 to 3 bar. The fact that the solids content of the dispersion will be slightly reduced by the condensate should be taken into account.

During the curing and/or after the curing, the calcium salt is added to the dispersion. It has proven advantageous to add the calcium salt in portions or continuously to the microcapsule dispersion during the curing, after the curing temperature has been reached, continuous addition being preferred. The amount of calcium salt to be added is from 0.5 to 15% by weight, particularly preferably from 1 to 10% by weight and in particular from 2 to 8% by weight, based on the melamine-formaldehyde resin. A particularly preferred method of addition is to start a feed of a calcium salt slurry or solution to the dispersion of pre-formed microcapsules at a mass flow rate which is substantially constant as a function of time, after the curing temperature has been reached. The mass flow rate is preferably chosen so that the addition extends over at least 50%, in particular at least 65%, of the duration of curing. The duration of curing is in general from 0.5 to 10 hours, typically from 1 to 3 hours.

The pH is preferably adjusted to 3.8 to 5.0, preferably about 4.5, and, if appropriate, maintained with an acid, e.g. formic acid.

It has furthermore proven advantageous to add melamine, i.e. cyanuric acid triamide, in portions or continuously to the microcapsule dispersion after the curing temperature has been reached, continuous addition being preferred. The added amount of melamine may be from 5 to 95.5% by weight, preferably from 7 to 40% by weight, in particular from 12.5 to 35% by weight, based on the melamine-formaldehyde resin. The addition is preferably effected in the manner described above for the calcium salt. The median particle size of the melamine particles in the slurry is preferably from 1 to 50 μm, in particular from about 1 to 5 μm. The median particle size can suitably be determined using a Malvern Sizer.

Particularly preferably, a mixture of calcium salt and melamine is added in portions or continuously, preferably as described above, during the curing of the microcapsule dispersion. Mixtures comprising calcium salt and melamine in a weight ratio of from 20:1 to 1:20, preferably from 1:1 to 1:10, are preferred.

It was furthermore found that the concomitant use of urea has a synergistic effect on the reduction of the formaldehyde content which can be determined by means of a cold water extract. The process according to the invention can therefore advantageously be carried out by adding a mixture of calcium salt, urea and melamine, e.g. having a weight ratio of from 1:1:3 to 1:10:15, preferably from 1:2:4 to 1:6:10, during the curing, expediently in the form of an aqueous calcium salt/melamine slurry which comprises the urea in dissolved form.

After the curing, a type of “postcuring” is preferably carried out, in which the dispersion is neutralized with an aqueous base, preferably sodium hydroxide solution, or made basic, preferably to a pH in the range of 9-12, preferably in the range of from 10 to 11.5.

Partly methylated melamine-formaldehyde resins, i.e. partial methyl ethers of melamine-formaldehyde resins having a molar ratio of melamine:formaldehyde:methanol of 1:3.0:2.0 to 1:6.0:4.0, preferably 1:3.5:2.2 to 1:4.5:2.8, in particular about 1:3.9:2.4, are preferably used as starting materials for the wall material. The methyl ethers are prepared, for example, in a manner analogous to that stated in DE 198 35 114, methanol being used as the alcohol and the procedure being effected without addition of melamine derivative. The molar ratios of melamine:formaldehyde:methanol of the melamine-formaldehyde resin used for the capsule preparation have a decisive influence on the resulting viscosity of the capsule dispersion. In the case of the stated molar ratios, the most advantageous combination of solids content and viscosity of the microcapsule dispersions is obtained.

Solid or gaseous, water-insoluble to substantially insoluble substances are suitable as core material for the microcapsules. For example, the following may be mentioned: liquids, such as alkylnaphthalenes, partly hydrogenated terphenyls, aromatic hydrocarbons, such as xylene, toluene and dodecylbenzene, aliphatic hydrocarbons, such as gasoline and mineral oil, paraffins, chloroparaffins, waxes of different chemical constitution, fluorohydrocarbons, natural oils, such as peanut oil and soybean oil, and also adhesives, flavors, perfume oils, monomers, such as acrylates or methacrylates, styrene, active substances, such as crop protection agents, red phosphorous, inorganic and organic pigments, e.g. iron oxide pigments; also solutions or suspensions of dyes and especially of color formers and pigments in hydrocarbons, such as alkylnaphthalenes, partly hydrogenated terphenyl, dodecylbenzene and other high-boiling liquids.

Suitable color formers are described in the publications mentioned at the outset.

The dispersing of the core material is effected in a known manner according to the size of the capsules to be prepared, as described, for example, in EP-A-0 026 914. Small capsules, particularly if the size is to be below 50 μm, require homogenizing or dispersing machines, it being possible to use these apparatuses with or without a forced through-flow apparatus. It is essential that homogenizing or dispersing machines are used at the beginning of the pre-forming phase. During the curing phase, the dispersion is only thoroughly mixed or circulated for uniform mixing under low-shear conditions.

The protective colloid used is an alkali metal salt of a homo- or copolymer of 2-acrylamido-2-methylpropanesulfonic acid, preferably the sodium salt. Suitable comonomers are acrylic acid, methacrylic acid, C₁₋₃-alkyl(meth)acrylates, hydroxy-C₂₋₄-(meth)acrylates and/or N-vinylpyrrolidone. The copolymer preferably comprises at least 40% by weight of 2-acrylamido-2-methylpropanesulfonic acid units. Suitable homo- and copolymers are described in EP-A-0 562 344. The protective colloid preferably has a Fikentscher K value of from 100 to 170 or a viscosity of from 200 to 5000 mPa·s (measured in 20% strength by weight aqueous solution at 23° C. in a Brookfield RVT apparatus, spindle 3 at 50 rpm). Polymers having a K value of from 115 to 150 or those whose viscosity is from 400 to 4000 mPa·s are particularly preferred.

The weight ratio of melamine-formaldehyde resin to protective colloid is preferably from 3:1 to 4.5:1, in particular from 3.5:1 to 4.0:1. The ratio of resin to protective colloid and the type of protective colloid influence the capsule size and the capsule size distribution.

The microcapsule dispersions prepared according to the invention have a desirably low viscosity, so that microcapsule dispersions having a high solids content can also be prepared with advantageous further processing properties. The microcapsule dispersions obtained generally have a solids content of from 15 to 60% by weight, preferably of at least 40% by weight, but preferably of at least 45% by weight, in particular at least 48% by weight, and particularly preferably from 50 to 53% by weight. The viscosity of the microcapsule dispersions (measured at 23° C. in a Brookfield RVT apparatus, spindle 3, at 50 rpm) is in general less than 100 mPa·s, in particular less than 90 mPa·s.

For the preparation of microcapsule dispersions having a high solids content, it is expedient to adopt a procedure in which a premix of melamine-formaldehyde resin, protective colloid and the material forming the capsule core is prepared, said premix having a solids content of at least 50% by weight, preferably about 55% by weight, the pre-forming of the microcapsules is effected from 20 to 50° C. and, for curing, the dispersion is heated to the curing temperature by injecting superheated steam, the solids content of the dispersion being reduced to the desired value, e.g. about 50% by weight, by the vapor condensate.

Dispersions of microcapsules advantageously having a narrow capsule size distribution which is characterized, for example, by a quotient (d₉₀-d₁₀)/d₅₀ (span) of from 0.3 to 0.8, preferably from 0.3 to 0.5, were obtainable by the process according to the invention. The d₁₀-d₅₀- and d₉₀-values indicate limits in relation to which 10%, 50% and 90%, respectively, of the capsules have a capsule diameter which is less than or equal to the limit. The d₁₀-d₅₀- and d₉₀ values can suitably be determined using a Malvern Sizer. Surprisingly—contrary to the expectation of the person skilled in the art—microcapsule dispersions having a desirably narrow size distribution are obtained even if premixes having a high solids content, e.g. more than 50% by weight, are used as starting materials. The microcapsules generally have a median diameter (d₅₀) in the range of from 1 to 50 μm, in particular from 3 to 8 μm. Aqueous microcapsule dispersions of this type having a core of a substantially water-insoluble material and a capsule wall of a condensed melamine-formaldehyde resin, the d₅₀ value of the diameter of the microcapsules being in the range of from 3 to 8 μm, the quotient (d₉₀-d₁₀)/d₅₀ being in the range of from 0.3 to 0.8, the solids content of the dispersion being at least 40% by weight, preferably at least 45% by weight, and the Brookfield viscosity of the dispersion at 23° C. and 50 rpm being less than 100 mPa·s, comprising from 0.5 to 15% by weight, based on the melamine-formaldehyde resin, of calcium salt, are preferred.

The present invention furthermore relates generally to aqueous microcapsule dispersions based on melamine-formaldehyde resins comprising from 0.5 to 15% by weight, based on the melamine-formaldehyde resin, of calcium salt.

The following examples are intended to explain the process according to the invention in more detail. The parts and percentages stated in the examples are parts by weight and percentages by weight, unless stated otherwise.

### EXAMPLES

Measuring Methods Used

1. Solids Content

The solids content stated in the examples is determined by drying (4 hours at 105° C.) and is composed substantially of the microcapsules and the water-soluble polymer. The capsule diameters were determined subjectively under the microscope and objectively using a Malvern Sizer. The capsule diameters are stated in μm as a d₅₀ value.

2. Viscosity

The viscosity of the capsule dispersions and the viscosity of the 20% strength solutions of the water-soluble protective colloid were measured at 23° C. using a Brookfield RVT apparatus with spindle 3 at 50 rpm. The K value was determined according to Fikentscher (Cellulosechemie 13 (1932) 58 et seq.), 0.5% strength in water.

3. Measurements of the Formaldehyde Concentration in Paper According to DIN EN 645 and DIN EN 1541

A paper (about 4.6 g/m²) coated with a coating slip which was obtained by thorough homogenization of 8.75 g of water, 8.25 g of microcapsule dispersion, 1.30 g of a powdered cellulose as a spacer (Arbocel® BSM 55) and 1.30 g of a 50% strength by weight commercially available binder dispersion based on a copolymer of styrene and butyl acrylate (Acronal® S 320 D) was comminuted according to DIN EN 645 and a cold water extract was produced. The formaldehyde in the filtrate was determined photometrically according to DIN 1541 with acetylacetone.

### Example 1

400 g of a 5% strength solution of a fluorane reactive dye mixture (consisting 5 parts of Pergascript® I-2RN, 20 parts of Pergascript I-2GN, 8 parts of Pergascript I-G, 67 parts of Pegascript I-R, from CIBA) in a mixture of diisopropyinaphthalene and linear alkane (boiling point 220° C.) in the ratio of 80:20, 69 g of 70% strength solution of a methylated melamine-formaldehyde resin (molar ratio of melamine:formaldehyde:methanol 1:3.9:2.4), 64 g of a 20% strength solution of poly-2-acrylamido-2-methylpropanesulfonic acid/sodium salt (K value 123; Brookfield viscosity of 770 mPa·s) 350 g of tap water and 15 g of 10% strength formic acid were introduced in succession into a cylindrically shaped 2 I stirred vessel having a built-in continuously regulatable disperser with a commercially available dispersing disk having a diameter of 50 mm and were processed to give a capsule dispersion by adjusting the stirring speed to have a circumferential speed of about 20 m/s. The temperature was kept at about 35° C.

After dispersing for 60 minutes, the dispersion was oil-free; a particle size of about 5 μm had been established. The stirring speed of the dispersing disk was then reduced to a value which was sufficient for uniform circulation of the vessel contents. After establishing the curing temperature of 80° C. by injection of superheated steam, the feed of a 64.2% strength aqueous slurry consisting of melamine/urea/calcium hydroxide in the weight ratio 6:3:1 was begun and a total of 39.5 g of the slurry was metered in over a period of 90 minutes. The pH was kept constant at 4.4 during this time with a 25% strength formic acid (HCOOH). After subsequent addition of 24 g of 25% strength sodium hydroxide solution, the dispersion had a pH of 11.0. Postcuring for 30 minutes at 80° C. and pH 11.0 was effected. After this curing phase of 120 minutes altogether, the dispersion was cooled to room temperature. The measured pH was 11.0.

A uniform capsule dispersion having a solids content of 50% and a viscosity of 83 mPa·s was obtained. The analysis of the free formaldehyde content in the cold water extract gave a value of 20 ppm and that of the free formaldehyde content in the dispersion gave a value of 0.01%.

The processing and copying properties of the capsule dispersion of the example meet the modern requirements.

### Comparative Example 1 (Not According to the Invention)

The procedure was as in example 1, except that, after reaching the curing temperature of 85° C., the feed of a 67.2% strength aqueous slurry consisting of melamine/urea in a weight ratio of 6.7:3.3 was begun and a total of 37.5 g of the slurry was metered in over a period of 90 minutes. The pH was kept constant at 4.3 during this time with a 25% strength formic acid (HCOOH). Postcuring for 30 minutes at 85° C. and pH 4.3 was effected. After this curing phase of 120 minutes altogether, the dispersion was cooled to room temperature and neutralized with diethanolamine and adjusted to a pH of 9.5 with 25% strength ammonia.

The analysis of the free formaldehyde content in the cold water extract gave a value of 100 ppm and that of the free formaldehyde content in the dispersion gave a value of 0.01%.

### Comparative Example 2

The procedure was as in example 1, except that, after reaching the curing temperature of 80° C., the feed of a 67.2% strength aqueous slurry consisting of melamine/urea in a weight ratio of 6.7:3.3 was begun and a total of 37.5 g of the slurry was metered in over a period of 90 minutes. The pH was kept constant at 4.4 during this time with a 25% strength formic acid (HCOOH). 28 g of a 25% strength sodium hydroxide solution were then added. The dispersion had a pH of 11.0. Postcuring for 30 minutes at 80° C. and pH 11.0 was effected. After this curing phase of 120 minutes altogether, the dispersion was cooled to room temperature. The measured pH was 11.5.

The analysis of the free formaldehyde content in the cold water extract gave a value of 200 ppm and that of the free formaldehyde content in the dispersion gave a value of 0.12%.

### Example 2

The procedure was as in example 1, except that, after reaching the curing temperature of 80° C., the feed of a 67.2% strength aqueous slurry consisting of melamine/urea in a weight ratio of 6.7:3.3 was begun and a total of 37.5 g of the slurry was metered in over a period of 90 minutes. The pH was kept constant at 4.4 during this time with a 25% strength formic acid (HCOOH). 5 g of a 50% strength calcium hydroxide slurry were then added, with subsequent addition of 24 g of a 25% strength sodium hydroxide solution. The dispersion had a pH of 11.0. Postcuring for 30 minutes at 80° C. and pH 11.0 was effected. After this curing phase of 120 minutes altogether, the dispersion was cooled to room temperature. The measured pH was 11.2.

The analysis of the free formaldehyde content in the cold water extract gave a value of 20 ppm and that of the free formaldehyde content in the dispersion gave a value of 0.01%.

### Example 3

The procedure was as in example 1, except that the addition of the 25% strength sodium hydroxide solution was reduced to 16 g. The dispersion had a pH of 10.6. Postcuring for 30 minutes at 80° C. and pH 10.6 was effected. After this curing phase of 120 minutes altogether, the dispersion was cooled to room temperature. The measured pH was 9.7.

The analysis of the free formaldehyde content in the cold water extract gave a value of 40 ppm and that of the free formaldehyde content in the dispersion gave a value of 0.02%.

We claim:

1. The use of at least one calcium salt for reducing the formaldehyde emission of microcapsule dispersions based on melamine-formaldehyde resins.

2. The use according to claim 1, the calcium salt used being calcium hydroxide.

3. The use according to claim 1 or 2, from 0.5 to 15% by weight, based on the melamine-formaldehyde resin, of calcium salt being used.

4. The use according to any of claims 1 to 3, by adding at least one calcium salt in a process for the preparation of microcapsules by condensation of a partly methylated melamine-formaldehyde resin having a molar ratio of melamine:formaldehyde:methanol of 1:3.0:2.0 to 1:6.0:4.0 in water, in which the substantially water-insoluble material forming the capsule core is dispersed, in the presence of a protective colloid at a pH of from 3 to 6.5, by pre-forming the microcapsules at a temperature of from 20 to 50° C. and subsequently curing the capsule wall at from >50 to 100° C., during and/or after curing.

5. A process for the preparation of microcapsule dispersions by the condensation of a melamine-formaldehyde resin, which, if appropriate, is partly methylated, in water in which the substantially water-insoluble material forming the capsule core is dispersed, in the presence of a protective colloid, by pre-forming the microcapsules and then curing the capsule wall, at least one calcium salt being added during and/or after the curing.

6. A process for the preparation of microcapsule dispersions by condensation of a partly methylated melamine-formaldehyde resin having a molar ratio of melamine:formaldehyde:methanol of 1:3.0:2.0 to 1:6.0:4.0 in water in which the substantially water-insoluble material forming the capsule core is dispersed, in the presence of a protective colloid at a pH of from 3 to 6.5, by pre-forming the microcapsules at a temperature of from 20 to 50° C. and then curing the capsule wall at from >50 to 100° C., in which at least one calcium salt is added during and/or after the curing.

7. The process according to claim 6, in which, after the curing temperature has been reached, a feed of a calcium salt slurry or solution having substantially constant mass flow as a function of time is started.

8. The process according to claim 6 or 7, in which a mixture of calcium salt and melamine having a calcium salt/melamine weight ratio of from 20:1 to 1:20 is added during the curing.

9. The process according to any of claims 6 to 8, in which at least one calcium salt is added at a temperature of from >50 to 100° C. and the mixture is then neutralized or rendered basic with an aqueous base.

10. A microcapsule dispersion obtainable by the process according to any of claims 5 to 9.

11. An aqueous microcapsule dispersion based on melamine-formaldehyde resins comprising from 0.5 to 15% by weight, based on the melamine-formaldehyde resin, of calcium salt.

12. An aqueous microcapsule dispersion comprising a core of a substantially water-insoluble material and a capsule wall of a condensed melamine-formaldehyde resin, the d₅₀ value of the diameter of the microcapsules being in the range of from 3 to 8 μm, the quotient (d₉₀-d₁₀)/d₅₀ being in the range of from 0.3 to 0.8, the solids content of the dispersion being at least 40% by weight and the Brookfield viscosity of the dispersion at 23° C. and 50 rpm being less than 100 mPa·s, comprising from 0.5 to 15% by weight, based on the melamine-formaldehyde resin, of calcium salt.

13. The use of the microcapsule dispersions according to any of claims 10 to 12 in the preparation of printing inks or paper coating materials.
